(19) United States
(12) Patent Application Publication
(10) Pub. No.: US 2010/0031261 A1
(43) Pub. Date: Feb. 4, 2010

(54) VIRTUAL SPACE PROVIDING SYSTEM, METHOD FOR CONTROLLING IMAGE FORMING APPARATUS, AND MEDIUM STORING PROGRAM THEREOF

(75) Inventor: Hiroyasu Morita, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/506,523

(22) Filed: Jul. 21, 2009

(30) Foreign Application Priority Data
Aug. 4, 2008 (JP) 2008-201190

(51) Int. Cl. G06F 9/46; G06F 3/048

(52) U.S. Cl. 718/100; 715/757

(57) ABSTRACT

It is determined whether a print command to a virtual image forming apparatus defined in the virtual space is a command to create a virtual output product by the virtual image forming apparatus, or a command to print an output product by the image forming apparatus that is linked to the virtual image forming apparatus. A virtual space providing system simulates printing of an output product by the image forming apparatus by creating virtual printed matter in the virtual space, when it is determined that the command is to create a virtual output product by the virtual image forming apparatus as a result of the determination. The virtual space providing system outputs the print command to the image forming apparatus, when it is determined that the command is to print an output product by the image forming apparatus that is linked to the virtual image forming apparatus.

### BACKGROUND OF THE INVENTION

1. Field of the Invention

The present invention relates to a virtual space providing system and a method for controlling an image forming apparatus and a medium storing program thereof.

2. Description of the Related Art

With the recent advancement of network techniques, the use of virtual three-dimensional worlds on the Internet is becoming popular amongst the general public as well. In such a virtual three-dimensional world, users not only simply communicate by chatting and the like, but users can operate an alter ego (in the following, referred to as an avatar) of the operator living in a virtual world to go shopping at a virtual store, and events can be held for the residents of the virtual world. The provision of new services involving such a virtual three-dimensional world has started.

Meanwhile, as various information exchanges have spread in such a virtual world, a demand has arisen for the reproduction of a document distributed in a virtual world to pass the document to a user in another virtual world. Also, a demanded has arisen for actually printing the document distributed in a virtual world on paper.

In this case, operability is demanded exclusively within a virtual world, like an avatar in the virtual world operating a virtual copier as if the user is copying a document using a copier in the real world. That is, if a receiver of the document is a human being in the real world, it is required that operations on a virtual copier are converted to information for controlling an actual copier, the job is sent to the actual copier, and the printing thereof is executed.

To solve such a problem, it has been proposed in Japanese Patent Laid-Open No. H10-222698 that an actual device is controlled by operating an avatar in a three-dimensional virtual world.

Japanese Patent Laid-Open No. H10-222698 describes that when information on operations corresponding to operations for controlling an actual domestic device is input by an operator's virtual alter ego in a three-dimensional virtual world, a domestic device to be controlled is specified using the information on such operations of the virtual domestic device and information for controlling a domestic device. It is also described that the protocol for controlling the device is transferred, and the device is controlled.

With the aforementioned conventional technique, it has been possible to control a real device via an avatar operating a virtual device in a virtual world. However, there has been no processing by a virtual world device in a virtual world. Thus, when an avatar performs processing in a closed virtual world, for example, reproducing a document in a virtual world, unlike operating a device in the real world, other operations become necessary, which may cause burden and confusion on the user's side, thus being undesirable in terms of operability.

Also, in conventional techniques, there is no such thing as obtaining the status of a real device, and reflecting such status in a virtual device in a virtual world. Therefore, even if some troubles occur in a real device and the user's intended processing cannot be carried out, the user cannot know about such a problem at the time of operating the virtual device. As a result, the user cannot tell that the processing was not executed until after a job has been loaded, causing burden on the user's side, such as, for example, requiring the job to be re-loaded.

### SUMMARY OF THE INVENTION

The present invention provides a virtual space providing program that can provide, in a virtual space, operability like an operator operating an apparatus in the real world, and the burden on the user's side can be reduced.

The present invention in its first aspect provides a computer-readable medium which stores a program for controlling an image forming apparatus, the program causing a computer to, in a virtual space providing system in which a computer that provides a virtual space and an image forming apparatus are connected via a network:

determine whether a print command to a virtual image forming apparatus defined in the virtual space is a command to create a virtual output product by the virtual image forming apparatus, or a command to print an output product by the image forming apparatus that is linked to the virtual image forming apparatus;

simulate printing of an output product by the image forming apparatus by creating virtual printed matter in the virtual space, when it is determined that the command is to create a virtual output product by the virtual image forming apparatus; and

output the print command to the image forming apparatus, when it is determined that the command is to print an output product by the image forming apparatus that is linked to the virtual image forming apparatus.

The present invention in its second aspect provides a virtual space providing system in which a computer that provides a virtual space and an image forming apparatus are connected via a network, comprising:

a determination unit configured to determine whether a print command to a virtual image forming apparatus defined in the virtual space is a command to create a virtual output product by the virtual image forming apparatus, or a command to print an output product by the image forming apparatus that is linked to the virtual image forming apparatus;

a simulation unit configured to simulate printing of an output product by the image forming apparatus by creating virtual printed matter in the virtual space, when it is determined that the command is to create a virtual output product by the virtual image forming apparatus as a result of the determination by the determination unit; and

an output unit configured to output the print command to the image forming apparatus, when it is determined that the command is to print an output product by the image forming apparatus that is linked to the virtual image forming apparatus.

The present invention in its third aspect provides a method for controlling an image forming apparatus that is executed in a virtual space providing system in which a computer that provides a virtual space and an image forming apparatus are connected via a network, the method comprising:

a determination step of determining whether a print command to a virtual image forming apparatus defined in the virtual space is a command to create a virtual output product by the virtual image forming apparatus, or a command to print an output product by the image forming apparatus that is linked to the virtual image forming apparatus;

a simulation step of simulating, printing of an output product by the image forming apparatus by creating virtual printed matter in the virtual space, when it is determined that the command is to create a virtual output product by the virtual image forming apparatus as a result of the determination in the determination step; and

an output step of outputting the print command to the image forming apparatus, when it is determined that the command is to print an output product by the image forming apparatus that is linked to the virtual image forming apparatus.

According to the present invention, when performing processing in a closed virtual world, that is, duplicating a document in the virtual world, operability like an operator operating an apparatus in the real world can be provided through an avatar operating a virtual image forming apparatus; and the burden on the user's side can be reduced.

Furthermore, because information on a related and existing device is reflected in a virtual device, the user is capable of knowing such device information in advance before loading a job. Thus, unnecessary burden on the user's side can be reduced, such as, for example, problems occurring in the device are being realized after the start of job processing, causing the job to be re-loaded.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a digital multi-function peripheral to which an image processing apparatus is applied.

FIG. 2 is a diagram illustrating a hardware configuration of a host computer in which a program module that provides a virtual three-dimensional space operates.

FIG. 3 is a diagram illustrating a system configuration to which the first embodiment is applied.

FIG. 4 is a diagram illustrating an example of an operation panel provided by a virtual image forming apparatus 308.

FIG. 5 is a diagram illustrating an example of a setting display of the virtual image forming apparatus 308.

FIG. 6 is a diagram illustrating an example of a display of the virtual image forming apparatus 308 reflecting a status of an existing image forming apparatus 304.

FIG. 7 is a flowchart illustrating the procedures of document print processing in the first embodiment.

FIGS. 8A and 8B are flowcharts illustrating the procedures of the processing by which the status of the existing image forming apparatus 304 is reflected in the virtual image forming apparatus 308.

FIG. 9 is a diagram illustrating a system configuration to which the second embodiment is applied.

FIG. 10 is a flowchart illustrating the processing procedures of a first virtual image forming apparatus in the second embodiment.

FIG. 11 is a diagram illustrating a system configuration to which the third embodiment is applied.

FIG. 12 is a flowchart illustrating the processing procedures of a virtual image forming apparatus in the third embodiment.

FIG. 13 is a flowchart illustrating the processing procedures of an existing image forming apparatus in the third embodiment.

FIG. 14 is a diagram illustrating an example of a script linked to the virtual image forming apparatus 308.

### DESCRIPTION OF THE EMBODIMENTS

Preferred embodiments for carrying out the present invention shall be described in detail hereinafter with reference to the drawings. Note that the same reference numerals will be appended to the same constituent elements, and a description thereof will be omitted.

### Embodiment 1

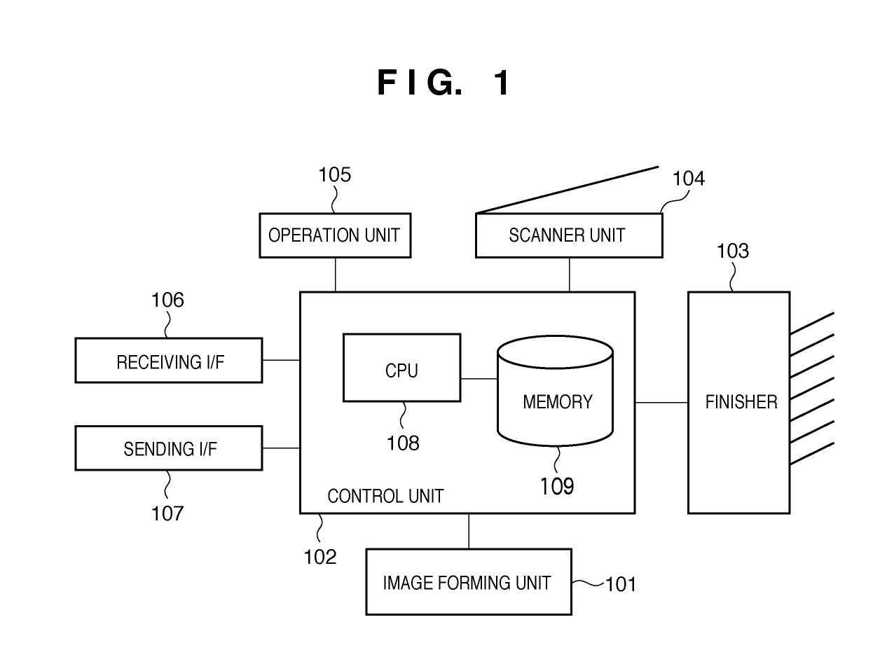

FIG. 1 is a block diagram illustrating a schematic configuration of a digital multi-function peripheral (MFP, providing a function such as a copy) to which an image processing apparatus is applied according to the present invention.

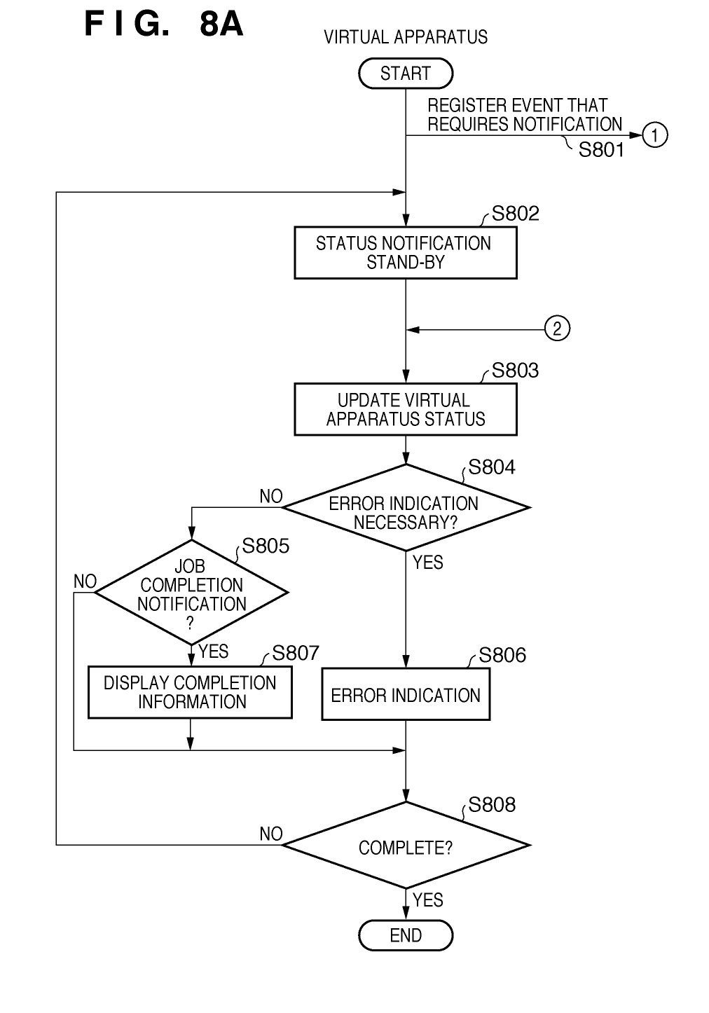

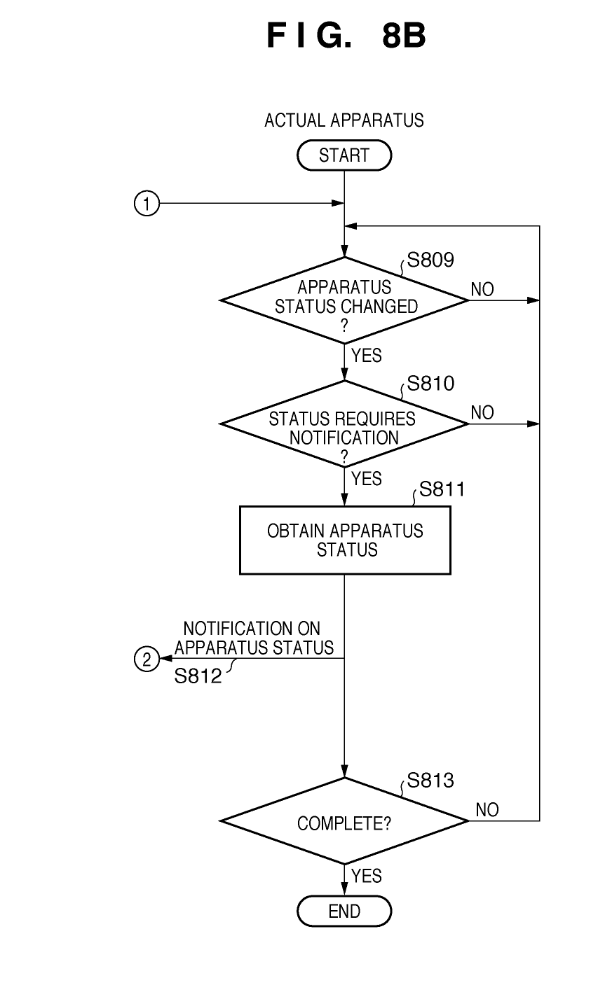

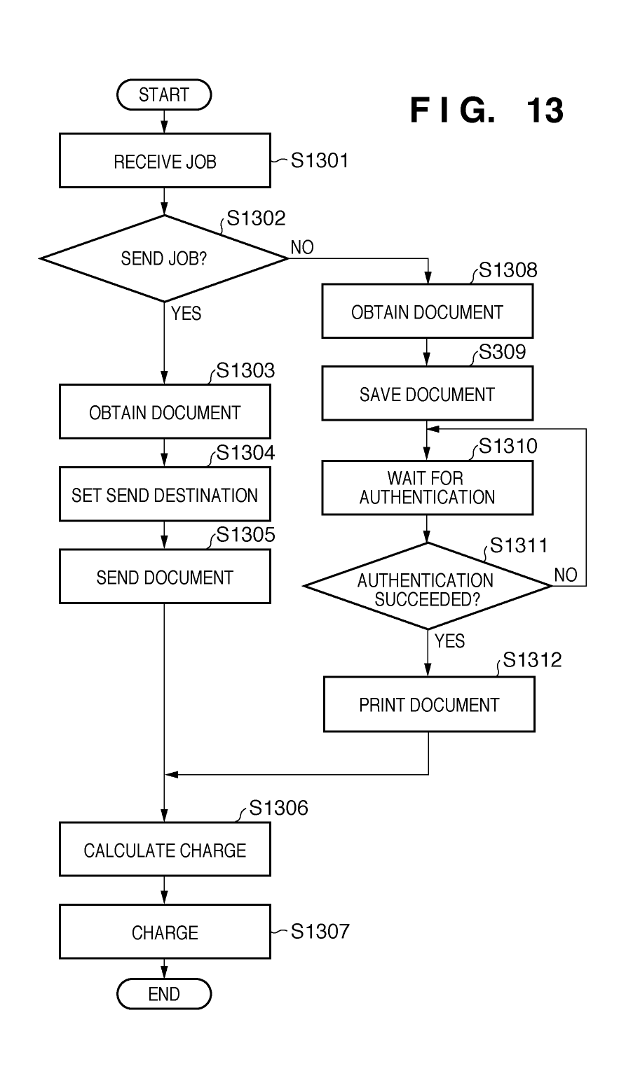

This MFP is provided with an image forming unit 101 that forms an image on a recording paper using an electrophotographic method or the like, and a control unit 102 that controls this MFP. Also provided are a finisher 103 that performs post-processing such as staple processing, a scanner unit 104 that reads the image of an original, and an operation unit 105 through which various data and commands are input. A plurality of receiving interfaces 106 for receiving scan data, Fax data, and the like are also provided. A plurality of sending interfaces 107 for sending scan data, Fax data, and the like are also provided, and these elements 101, and 103 to 107 are connected to the control unit 102 through their respective dedicated interfaces. The main unit of the control unit 102 is composed of a central processing unit (CPU) 108 and a storage device (memory) 109. The memory 109 stores control programs corresponding to the flowcharts of FIG. 7, FIG. 8A, FIG. 8B, and FIG. 13; content in which information on operation screens is written; and the like.

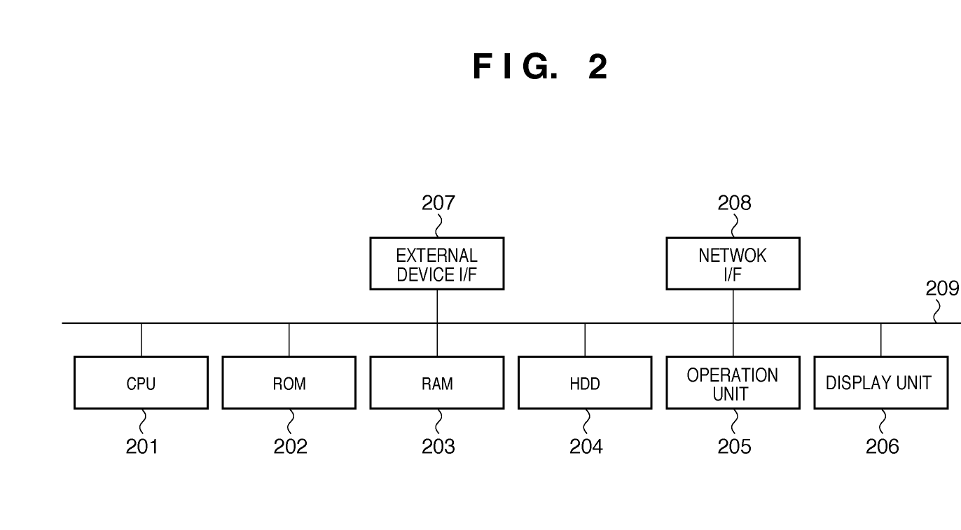

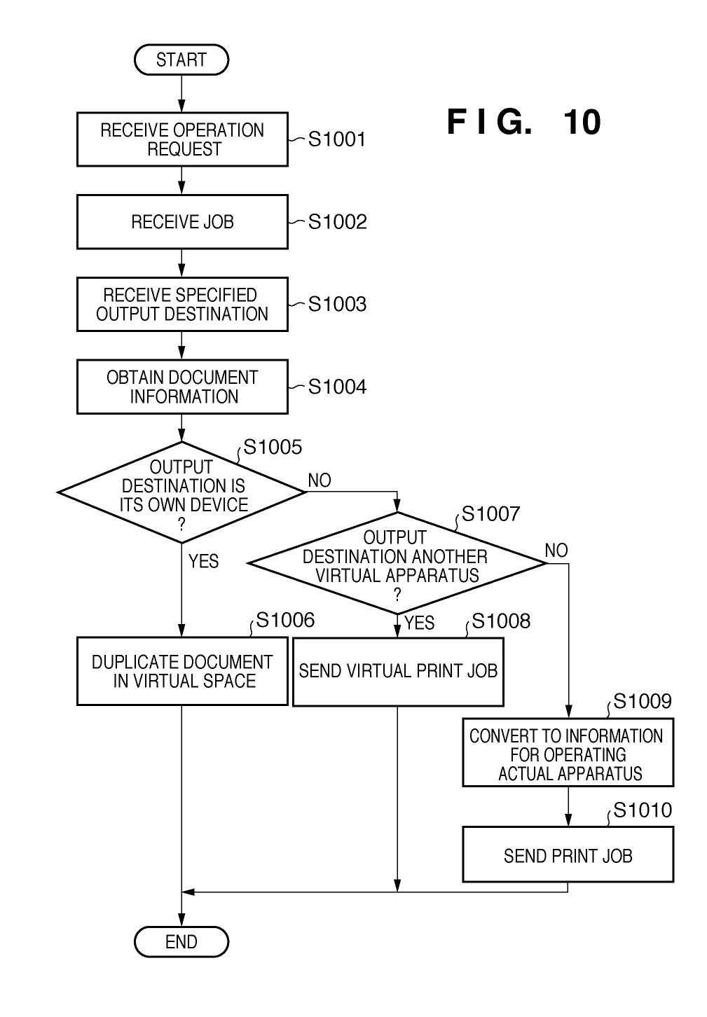

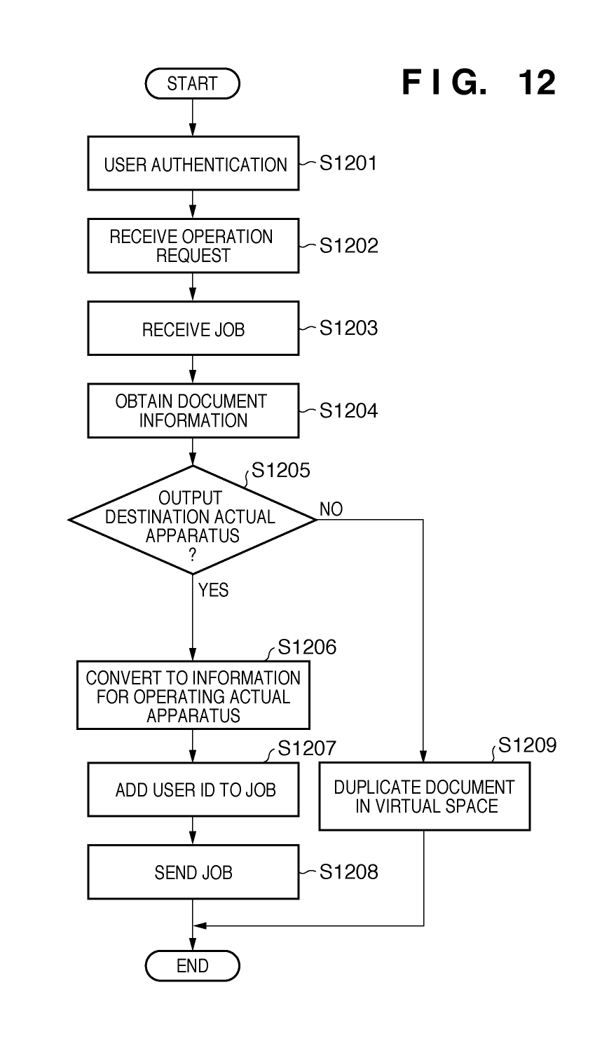

FIG. 2 is a diagram illustrating a hardware configuration of a host computer in which a program module that provides a virtual three-dimensional space operates. In this host computer, a CPU 201 controls respective processes in the computer. A ROM 202 which cannot be re-written stores programs and data relating to respective processes in the computer. A RAM 203 is capable of electrically storing temporary data related to the respective processes in the computer, and can be re-written. A HDD 204 stores programs and data related to the respective processes in the computer; temporary data; control programs corresponding to the flowcharts in FIG. 7, FIG. 8A, FIG. 8B, FIG. 10, and FIG. 12; information collected from the image forming apparatus; and the like. An operation unit 205 is, for example, a keyboard or a pointing device that receives the input of instructions to the computer. A display unit 206 displays the operational state of the computer, and information output by the respective programs operating on the computer. A network I/F 208 is connected to a LAN and the Internet via a network, and exchanges information with the outside. An external device I/F 207 connects to an external storage device and the like. Those components are connected by a system bus 209, and exchange data.

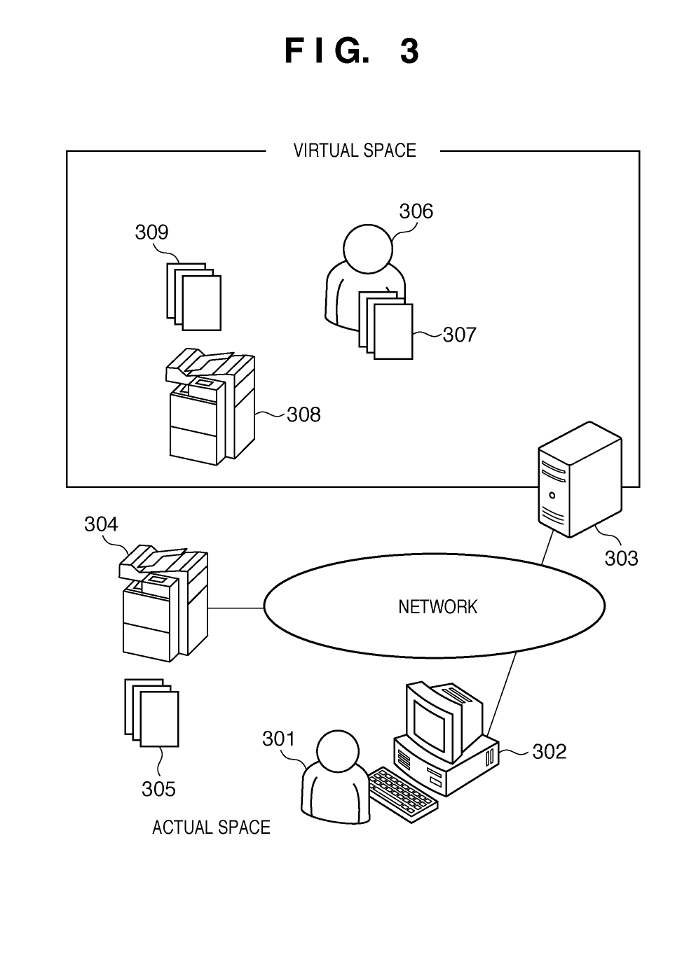

FIG. 3 is a diagram illustrating a system configuration to which this embodiment is applied. In this embodiment, the system shown in FIG. 3 is also referred to as a virtual space providing system. In FIG. 3, reference numeral 301 is an actual operator, and reference numeral 302 is a personal computer used by the operator. Reference numeral 303 is a host computer that provides a virtual three-dimensional space. Reference numeral 304 is an existing image forming apparatus, and is connected to the host computer 303 via a network. Reference numeral 305 is actual printed matter.

Reference numeral 306 is an avatar, that is, an alter ego of the operator 301 in a virtual three-dimensional space, and is embodied in the virtual three-dimensional space by the operator 301 making a connection to the host computer 303 via the personal computer 302. Reference numeral 308 is a virtual image forming apparatus that is linked to the existing image forming apparatus 304, and is embodied and disposed in the virtual three-dimensional space in advance. Reference numeral 307 is a document in the virtual three-dimensional space, and reference numeral 309 is a document duplicated from 307.

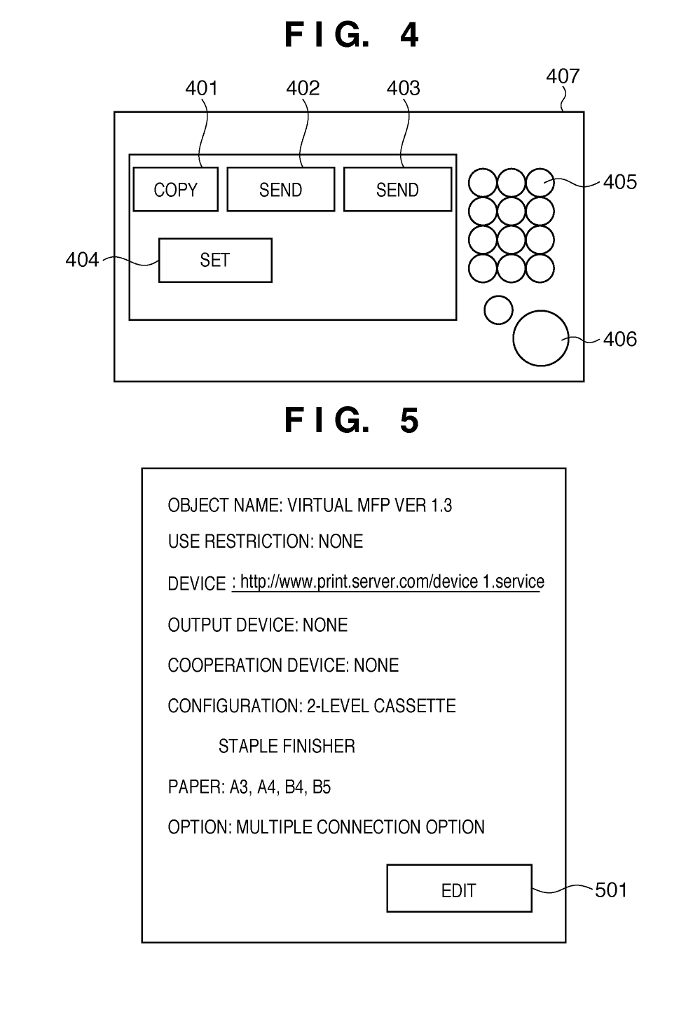

FIG. 4 is a diagram illustrating an operation panel provided by the virtual image forming apparatus 308. In FIG. 4, reference numeral 401 is a button for selecting a copier function in the virtual three-dimensional space, and reference numeral 402 is a button for selecting a send function in the virtual three-dimensional space. Reference numeral 403 is a button for selecting a function of performing processing using the existing apparatus that is linked to the virtual image forming apparatus 308. Reference numeral 404 is a button for selecting a function of displaying and editing current settings, reference numeral 405 is a numerical keypad, and reference numeral 406 is a start key. An operation unit 407 is mainly composed of these function buttons.

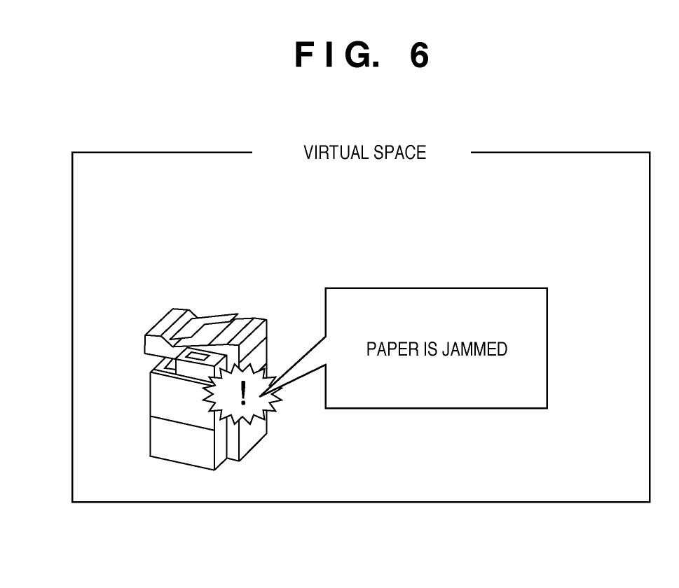

FIG. 5 is an example of a setting display of the virtual image forming apparatus 308. In FIG. 5, the object name of the virtual image forming apparatus, use restrictions, the address of the existing image forming apparatus 304 that is linked thereto, the apparatus configuration, sheets, option information, and the like are displayed. By pressing an “edit” button 501, the settings can be edited.

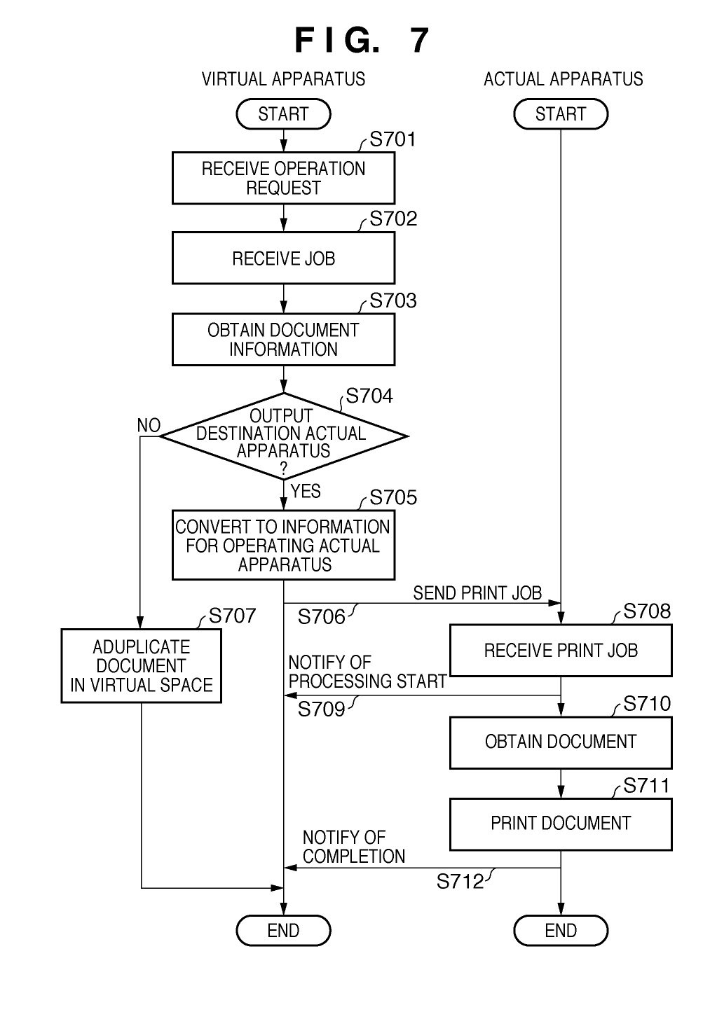

FIG. 6 is an example of a display of the virtual image forming apparatus 308 reflecting the status of the existing image forming apparatus 304. In FIG. 6, because a paper jam occurred in the existing image forming apparatus 304, a mark that indicates a problem has occurred in the apparatus and a message that indicates the details of the problem are displayed.

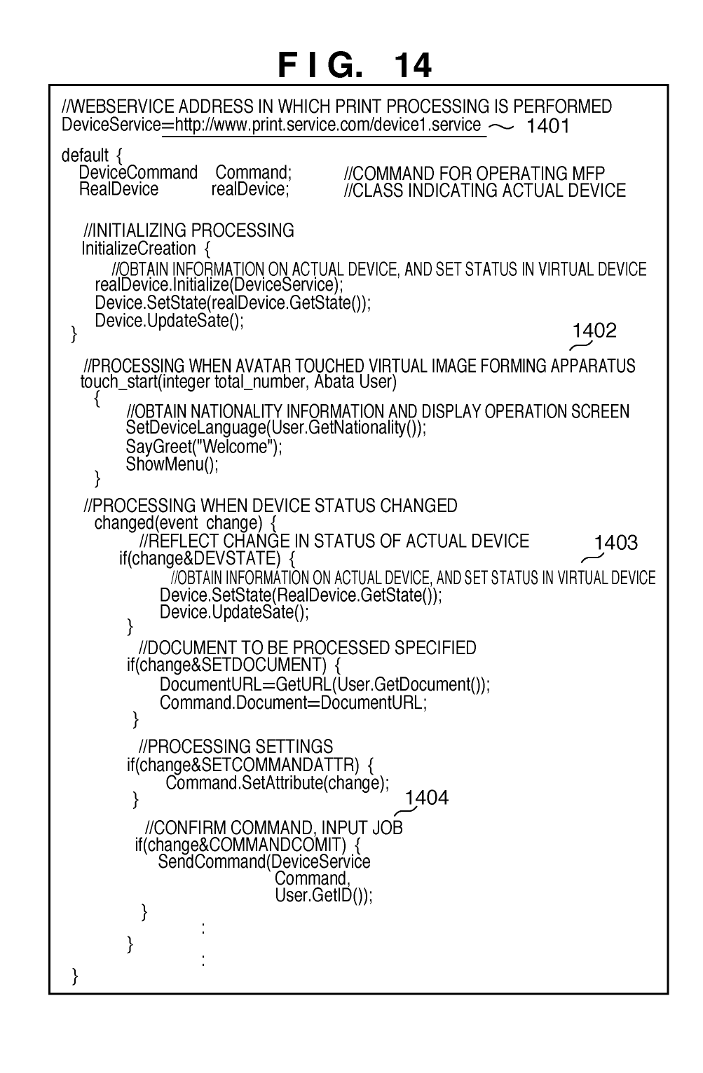

FIG. 7 is a flowchart illustrating the procedures of document print processing in this embodiment. The operations shown in FIG. 7 are executed according to the script shown in FIG. 14 to be mentioned later. The script shown in FIG. 14 is stored in the ROM 202 and the like of the host computer 303, and executed by the CPU 201.

FIG. 14 is an example of a script linked to the virtual image forming apparatus 308. In the script shown in FIG. 14, the details of the processing carried out by the host computer 303 according to the operations of the avatar 306 on the virtual image forming apparatus 308 in the virtual space actualized by the host computer 303 are written. For example, details such as sending a print job to the image forming apparatus 304 from the host computer 303 according to the print operation performed by the avatar 306 on the virtual image forming apparatus 308 are written.

In the script shown in FIG. 14, the address of the existing image forming apparatus 304 linked to the virtual image forming apparatus 308 is written (1401). Also, the details of the processing in response to an operation request from the avatar (1402), the processing in correspondence with a status change in the existing image forming apparatus (1403), the processing relating to job execution (1404), and the like are written.

In FIG. 7, first, in the virtual image forming apparatus 308, an operation request from the avatar 306 in the virtual three-dimensional space is received (step S701), and the details of the processing of the virtual document 307 are received via the virtual operation unit 407 (step S702). Examples of such processing details include, copying in the virtual space, print processing using the existing image forming apparatus, and the like. In such a case, the operation request will be a print command.

Next, document information on the virtual document 307 is obtained, and the address where the document exists, the document format, and the like are obtained (step S703). Then, it is determined whether or not the output destination apparatus used in the processing received in step S702 is the existing apparatus (step S704). If the determination result is Yes in step S704, the operation performed by the avatar 306 on the virtual image forming apparatus 308 in step S702 is converted to information for controlling the existing image forming apparatus 304 that is linked to the virtual image forming apparatus 308 (step S705). Next, the control information created in step S705 is sent to the existing image forming apparatus 304 as a print job via the network (step S706), and the processing in the virtual image forming apparatus 308 ends.

If the determination result in step S704 is No, the document is duplicated in the virtual space based on the document information obtained in step S703 (step S707), and the processing ends. That is, by creating a virtual output product using the virtual image forming apparatus 308, the output of printed matter from the existing image forming apparatus 304 is simulated. In the actual image forming apparatus 304, first, the print job sent from the virtual image forming apparatus 308 in step S706 is received (step S708). Next, a notification to start processing is given to the virtual image forming apparatus 308 via the network (step S709), the document to be printed is obtained based on the document information obtained in step S702 (step S710), and the document is printed (step S711). After printing the document in step S711, a notification of the print result is given to the virtual image forming apparatus 308 (step S712), and the processing ends.

As described above, in this embodiment, when performing processing in a closed virtual world, that is, duplicating a document in the virtual world, operability like an operator operating an apparatus in the real world can be provided through an avatar operating a virtual image forming apparatus. The burden can be reduced even when an operator is operating using an avatar because as shown in FIG. 4 and FIG. 5, the operation method employed when operating with an avatar is uniform with that of the existing image forming apparatus.

FIGS. 8A and 8B are flowcharts illustrating the procedures of the processing by which the status of the existing image forming apparatus 304 is reflected in the virtual image forming apparatus 308. The operations shown in FIGS. 8A and 8B are executed in accordance with the script shown in FIG. 14. First, the virtual image forming apparatus 308 registers events requiring notification in the existing image forming apparatus 304 via the network (step S801), and the status becomes a status notification stand-by status (step S802).

In the existing image forming apparatus 304, after registering an event that requires notification in step S801, it is determined whether or not the status of the apparatus has changed (step S809). If the determination result in step S809 is Yes, comparison is made with the information on the event that requires notification about which notification was given in step S801, and it is determined whether or not the status requires that notification be given to the virtual image forming apparatus 308 (step S810). If the determination result in step S809 or step S810 is No, the processing returns to step S809.

If the determination result in step S810 is Yes, the status of the apparatus is obtained (step S811), and a notification on the status of the apparatus is given to the virtual image forming apparatus 308 (step S812) The virtual image forming apparatus 308 receives the notification on the apparatus status of step S812, and updates the status of the virtual apparatus (step S803). Then, by referring to the update details of step S803, it is determined whether or not the status notification given requires that an error be indicated (step S804).

If the determination result in step S804 is Yes, the display of the virtual image forming apparatus 308 is changed to an error display, and error information is displayed (step S806). If the determination result in step S804 is No, by referring to the details updated in step S803, it is determined whether or not the status notification that was given was a job termination notification (step S805).

If the determination result in step S805 is Yes, the display on the virtual image forming apparatus 308 is changed to a display used when a job termination notification was received, and the result of the job is displayed (step S807).

If the determination result in step S805 is No, the display does not have to be changed particularly. If the determination result in step S805 is No, it is determined whether or not the notification of processing termination was received from the avatar after the processing in step S807 or step S805 (step S808).

As described above, in this embodiment, the status of the existing image forming apparatus 304 is received, and the status display can be simulated in the linked virtual image forming apparatus 308 (an example of a second simulation in this embodiment).

If the determination result is Yes in step S808, the processing ends, and if the determination result is No, the processing returns to step S802. In the existing image forming apparatus 304, it is determined whether or not the notification of processing termination was received from the user after notifying the virtual image forming apparatus 308 of the status of the apparatus in step S812 (step S813).

If the determination result is Yes in step S813, the processing ends, and if the determination result is No, the processing returns to step S809.

### Embodiment 2

With a real image forming apparatus, sometimes an image forming apparatus that is different from its own apparatus is specified as the output destination in an attempt to shorten printing time, and in order to perform processing in the different apparatus that cannot be carried out within its own apparatus. Similar effects can be obtained by realizing such a system with a virtual image forming apparatus as well.

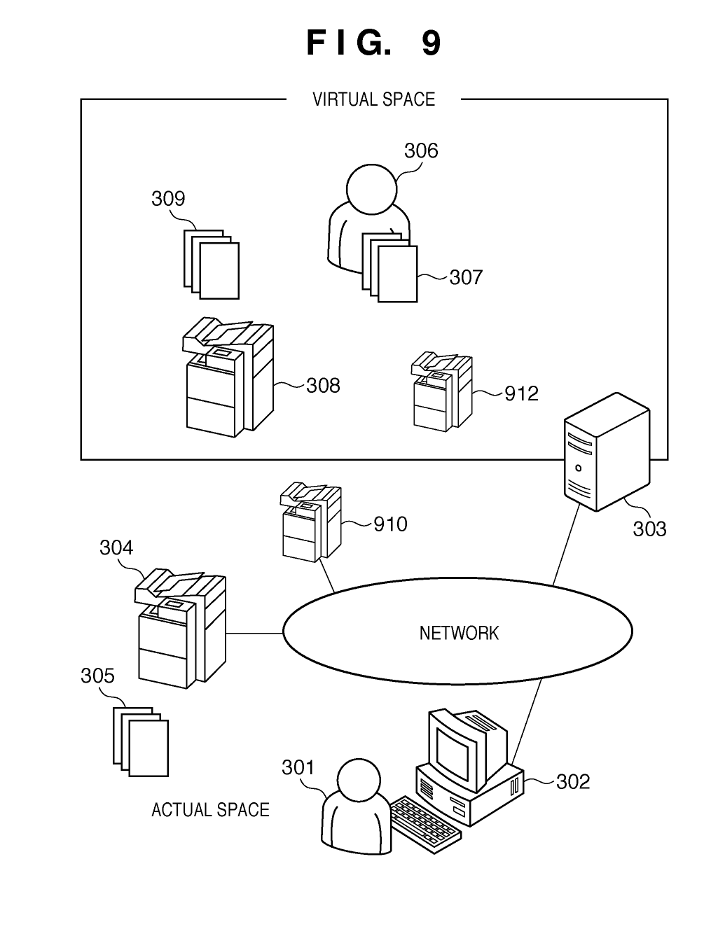

FIG. 9 is a diagram illustrating a system configuration to which this embodiment is applied. In FIG. 9, reference numeral 301 is an actual operator, reference numeral 302 is a personal computer used by the operator. Reference numeral 303 is a host computer that provides a virtual three-dimensional space. Reference numeral 304 is a first existing image forming apparatus, and reference numeral 910 is a second existing image forming apparatus. These are connected to the host computer 303 via a network. Reference numeral 305 is actual printed matter.

Reference numeral 306 is an avatar, that is, an alter ego of the operator 301 in a virtual three-dimensional space, and is embodied in the virtual three-dimensional space by the operator 301 making a connection to the host computer 303 via the personal computer 302. Reference numeral 308 is a first virtual image forming apparatus that is linked to the existing image forming apparatus 304, and is embodied in the virtual three-dimensional space in advance. Reference numeral 307 is a document in the virtual three-dimensional space, reference numeral 309 is a document duplicated from 307, and reference numeral 912 is a second virtual image forming apparatus.

FIG. 10 is a flowchart illustrating the processing procedures of a first virtual image forming apparatus in this embodiment. The operations shown in FIG. 10 are executed in accordance with the script shown in FIG. 14. First, in the first virtual image forming apparatus 308, an operation request from the avatar 306 in the virtual three-dimensional space is received (step S1001), and the details of processing of the virtual document 307 are received via the virtual operation unit 407 (step S1002). Next, the apparatus of the output destination is set via the virtual operation unit 407 (step S1003). Any of the first virtual image forming apparatus itself, the second virtual image forming apparatus, and the second actual image forming apparatus that is not linked to the first virtual image forming apparatus can be set as the apparatus of the output destination.

Next, document information on the virtual document 307 is obtained, and the address where the document exists, the document format, and the like are obtained (step S1004). After the processing in step S1004, it is determined whether or not the output destination apparatus specified in step S1003 is its own apparatus (step S1005). If the determination result is Yes in step S1005, the document is duplicated in the virtual space based on the document information obtained in step S1004 (step S1006), and the processing ends.

If the determination result in step S1005 is No, it is determined whether or not the output destination apparatus specified in step S1003 is the second virtual image forming apparatus 912 (step S1007). If the determination result is Yes in step S1007, a virtual print job is sent to the second virtual image forming apparatus 912 (step S1008).

If the determination result in step S1007 is No, the output destination apparatus specified in step S1003 is the existing image forming apparatus. The operation performed by the avatar 306 on the first virtual image forming apparatus 308 in step S1002 is converted to information for controlling the second existing image forming apparatus 910 (step S1009). Next, the control information created in step S1009 is sent to the second existing image forming apparatus 910 as a print job via the network (step S1010), and the processing ends.

### Embodiment 3

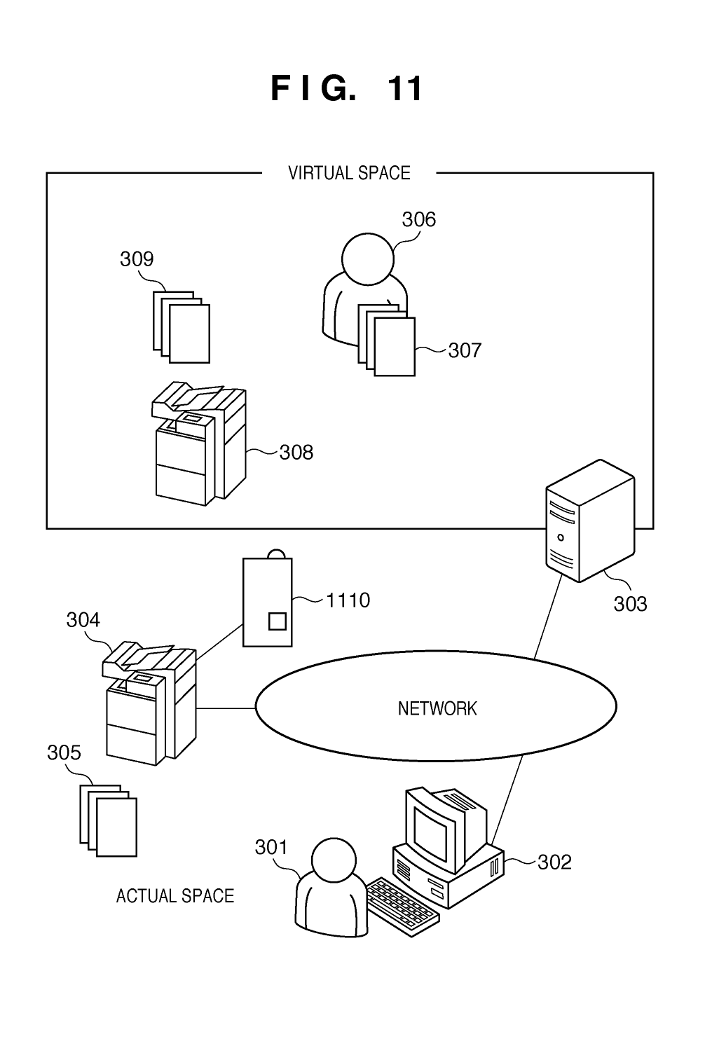

As services involved with such virtual three-dimensional spaces become popular, there is an increase in demand for the users to be charged for the services used. FIG. 11 is a diagram illustrating a system configuration to which this embodiment is applied.

In FIG. 11, reference numeral 301 is an actual operator, and reference numeral 302 is a personal computer used by the operator. Reference numeral 303 is a host computer that provides a virtual three-dimensional space. Reference numeral 304 is an existing image forming apparatus. These are connected to the host computer 303 via a network. Reference numeral 1110 is a coin-operated vending machine, and is connected to the image forming apparatus 304 via a serial interface. Reference numeral 305 is actual printed matter.

Reference numeral 306 is an avatar, that is, an alter ego of the operator 301 in a virtual three-dimensional space, and is embodied in the virtual three-dimensional space by the operator 301 making a connection to the host computer 303 via the personal computer 302. Reference numeral 308 is a virtual image forming apparatus that is linked to the existing image forming apparatus 304, and is embodied in the virtual three-dimensional space in advance. Reference numeral 307 is a document in the virtual three-dimensional space, and reference numeral 309 is a document duplicated from 307.

FIG. 12 is a flowchart illustrating the processing procedures of a virtual image forming apparatus in this embodiment. The operations shown in FIG. 12 are executed in accordance with the script shown in FIG. 14. The operator 301 who operates the avatar 306 in the virtual three-dimensional space is authenticated in the virtual image forming apparatus 308 (step S1201). Next, an operation request is received (step S1202), and the details of processing of the virtual document 307 are received via the virtual operation unit 407 (step S1203). Next, document information on the virtual document 307 is obtained, and the address where the document exists, the document format, and the like are obtained (step S1204).

Next, it is determined whether or not the output destination apparatus used in the processing received in step S1202 is the existing apparatus (step S1205). If the determination result is Yes in step S1205, the operation performed by the avatar 306 on the virtual image forming apparatus 308 in step S1202 is converted to information for controlling the existing image forming apparatus 304 that is linked to the virtual image forming apparatus 308 (step S1206).

Next, the user ID that specifies the operator 301 obtained in the authentication processing in step S1201 is added to the job received in step S1202 (step S1207). Furthermore, via the network, the control information created in step S1206 and to which the user ID is added in step S1207 is sent to the existing image forming apparatus 304 (step S1208), and the processing ends.

If the determination result in step S1205 is No, the document is duplicated in the virtual space based on the document information obtained in step S1204 (step S1209), and the processing ends.

FIG. 13 is a flowchart illustrating the processing procedures of an existing image forming apparatus in this embodiment. The operations shown in FIG. 13 are executed in accordance with the script shown in FIG. 14. First, the job sent from the virtual image forming apparatus 308 in step S1208 is received (step S1301), and it is determined whether or not the job received in step S1301 is a send job (step S1302).

If the determination result in step S1302 is Yes, the document to be sent is obtained based on the document information obtained in step S1204 (step S1303). Furthermore, the destination of sending is set according to the settings of the job received in step (step S1304), and the document is sent to the specified destination (step S1305).

If the determination result in step S1302 is No, the job received in step S1301 is determined to be a print job. The document to be printed is obtained based on the document information obtained in step S1204 (step S1308), the document to be printed obtained in step S1308 is stored in a storage device of the existing image forming apparatus 304 (step S1309), and the status thereof is shifted to an authentication stand-by status (step S1310).

Next, the user who is using the existing image forming apparatus 304 is authenticated, and it is determined whether or not the user using the apparatus is the same user who sent the print job in step S1208 (step S1311).

If the determination result in step S1311 is Yes, the document stored in the storage device of the image forming apparatus 304 in step S1309 is printed (step S1312), and if the determination result is No, the processing returns to step S1310.

After the completion of the send process in step S1305 or print processing in step S1312, the charge for the processing is calculated (step S1306). Next, the amount calculated in step S1306 is charged to the user ID added to the job sent in step S1208 (step S1307), and the processing ends.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-201190, filed Aug. 4, 2008 which is hereby incorporated by reference herein in its entirety.

What is claimed is:

1. A computer-readable medium which stores a program for controlling an image forming apparatus, the program causing a computer to, in a virtual space providing system in which a computer that provides a virtual space and an image forming apparatus are connected via a network:
determine whether a print command to a virtual image forming apparatus defined in the virtual space is a command to create a virtual output product by the virtual image forming apparatus, or a command to print an output product by the image forming apparatus that is linked to the virtual image forming apparatus;
simulate printing of an output product by the image forming apparatus by creating virtual printed matter in the virtual space, when it is determined that the command is to create a virtual output product by the virtual image forming apparatus; and
output the print command to the image forming apparatus, when it is determined that the command is to print an output product by the image forming apparatus that is linked to the virtual image forming apparatus.

2. The medium which stores the program according to claim 1, the program further causing a computer to simulate displaying of the status of the image forming apparatus.

3. The medium which stores the program according to claim 2, wherein the status of the image forming apparatus includes at least one of termination of print processing based on the print command and an error.

4. The medium which stores the program according to claim 1, wherein when it is determined that the command is to create a virtual output product by a first virtual image forming apparatus that is different from the virtual image forming apparatus, virtual printed matter is created by the first virtual image forming apparatus.

5. The medium which stores the program according to claim 4, wherein when it is determined that the command is to create an output product by a first image forming apparatus that is different from the image forming apparatus that is linked to the virtual image forming apparatus, the print command is output to the first image forming apparatus.

6. The medium which stores the program according to claim 1, wherein the simulated printing by the virtual image forming apparatus is not charged for, whereas the printing by the image forming apparatus based on the print command is charged for.

7. A virtual space providing system in which a computer that provides a virtual space and an image forming apparatus are connected via a network, comprising:
a determination unit configured to determine whether a print command to a virtual image forming apparatus defined in the virtual space is a command to create a virtual output product by the virtual image forming apparatus, or a command to print an output product by the image forming apparatus that is linked to the virtual image forming apparatus;
a simulation unit configured to simulate printing of an output product by the image forming apparatus by creating virtual printed matter in the virtual space, when it is determined that the command is to create a virtual output product by the virtual image forming apparatus as a result of the determination by the determination unit; and
an output unit configured to output the print command to the image forming apparatus, when it is determined that the command is to print an output product by the image forming apparatus that is linked to the virtual image forming apparatus.

8. A method for controlling an image forming apparatus that is executed in a virtual space providing system in which a computer that provides a virtual space and an image forming apparatus are connected via a network, the method comprising:
a determination step of determining whether a print command to a virtual image forming apparatus defined in the virtual space is a command to create a virtual output product by the virtual image forming apparatus, or a command to print an output product by the image forming apparatus that is linked to the virtual image forming apparatus;
a simulation step of simulating, printing of an output product by the image forming apparatus by creating virtual printed matter in the virtual space, when it is determined that the command is to create a virtual output product by the virtual image forming apparatus as a result of the determination in the determination step; and
an output step of outputting the print command to the image forming apparatus, when it is determined that the command is to print an output product by the image forming apparatus that is linked to the virtual image forming apparatus.
